(19) United States
(12) Patent Application Publication
(10) Pub. No.: US 2020/0267069 A1
(43) Pub. Date: Aug. 20, 2020

(54) LINK SWITCHING METHOD, LINK SWITCHING DEVICE, NETWORK COMMUNICATION SYSTEM, AND COMPUTER-READABLE STORAGE MEDIUM

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventor: Dong LI, Beijing (CN)

(21) Appl. No.: 16/649,963

(22) PCT Filed: Jul. 23, 2019
(86) PCT No.: PCT/CN2019/097263

§ 371 Date: Mar. 23, 2020

(30) Foreign Application Priority Data
Jul. 24, 2018 (CN) 201810821707.7

(51) Int. Cl. H04L 12/26; H04L 12/707; H04L 12/703; H04L 12/24

(52) U.S. Cl. CPC H04L 43/0841; H04L 43/0811; H04L 41/12; H04L 45/28; H04L 45/22

(57) ABSTRACT

A link switching method and a link switching device, a network communication system, and a computer-readable storage medium are described. The link switching method includes: monitoring whether a connection state of a first link between a first network device and a second network device is abnormal; and in response to the monitored connection state of the first link being abnormal, sending a pre-configured data packet to the first network device for being invoked by the first network device to perform a link switching from the first link to a second link.

### TECHNICAL FIELD

The present disclosure relates to the field of communication technologies, and in particular, to a link switching method, a link switching device, a network communication system, and a computer-readable storage medium.

### BACKGROUND

At present, with the rapid development of communication technology, large-scale communication networks across regions and even territories have gradually matured. In large communication networks, core devices can provide network services for a large number of terminal devices.

In a communication network, since the bandwidth of a single link cannot meet service requirements, in practical applications, service traffic must be divided by routing, and individual links carry different services respectively. Because a large number of static routing or policy routing are configured on each device, when one link fails, services on the link will be completely interrupted. In this case, for large-scale communication networks across regions or territories, administrators in different locations are required to manually switch links at the same time to transfer services to other links. However, once the administrator of one party cannot be contacted in time or cannot arrive at the operation site in time, the communication services between the two parties located respectively in two places will be interrupted for a long time, which will affect the office and production of the two places.

### SUMMARY

According to an aspect of the present disclosure, there is provided a link switching method comprising: monitoring whether a connection state of a first link between a first network device and a second network device is abnormal; and in response to the monitored connection state of the first link being abnormal, sending a pre-configured data packet to the first network device for being invoked by the first network device to perform a link switching from the first link to a second link.

In some embodiments of the link switching method according to the present disclosure, the method further comprises: before the sending a pre-configured data packet to the first network device, generating the pre-configured data packet for the first network device, wherein the pre-configured data packet comprises a link configuration item and a configuration script required for switching the first link to the second link.

In some embodiments of the link switching method according to the present disclosure, the monitoring whether the connection state of the first link between the first network device and the second network device is abnormal comprises: sending one or more link test data packets to the second network device via the first network device to request a response message of the second network device; in response to no response message of the second network device being received within a first time threshold since each of the one or more link test data packets being sent, determining that the link test data packet is lost; and determining that the connection state of the first link is abnormal according to at least one of: a number of lost link test data packets in the one or more link test data packets is greater than a first number threshold, or a number of consecutively lost link test data packets in the one or more link test data packets is greater than a second number threshold.

In some embodiments of the link switching method according to the present disclosure, the method further comprises: after completing each step of the method, generating a log record of the step.

In some embodiments of the link switching method according to the present disclosure, at least one of the first link and the second link is a network dedicated line link or a virtual private network link.

In some embodiments of the link switching method according to the present disclosure, the link configuration item comprises at least one of an access control list, a routing priority configuration item, a routing configuration item, and a port disable configuration item.

In some embodiments of the link switching method according to the present disclosure, the method further comprises, in response to the monitored connection state of the first link being abnormal, while sending the pre-configured data packet to the first network device, sending a further pre-configured data packet to the second network device for being invoking by the second network device to perform the link switching from the first link to the second link.

In some embodiments of the link switching method according to the present disclosure, each of the first network device and the second network device comprises at least one of a switch, a router, a firewall, a server, and a client.

According to another aspect of the present disclosure, there is provided another link switching method comprising: obtaining a pre-configured data packet for switching a first link between a first network device and a second network device to a second link; and invoking the pre-configured data packet to perform a link switching from the first link to the second link.

In some embodiments of another link switching method according to the present disclosure, the pre-configured data packet comprises a configuration script and a link configuration item required for switching the first link to the second link, and wherein the invoking the pre-configured data packet to perform the link switching from the first link to the second link comprises: invoking the configuration script in the pre-configured data packet to replace the link configuration item of the first link with the link configuration item in the pre-configuration data packet; or invoking the configuration script in the pre-configured data packet to disable the link configuration item of the first link and enable the link configuration item in the pre-configuration data packet.

According to yet another aspect of the present disclosure, there is provided a link switching device comprising: a link monitoring module configured to monitor whether a connection state of a first link between a first network device and a second network device is abnormal; a first pre-configured data packet sending module configured to: in response to the monitored connection state of the first link being abnormal, send a first pre-configured data packet to the first network device for being invoked by the first network device to perform a link switching from the first link to a second link.

In some embodiments of the link switching device according to the present disclosure, the link switching device further comprises a second pre-configured data packet sending module configured to: in response to the monitored connection state of the first link being abnormal, send a second pre-configured data packet to the second network device for being invoked by the second network device to perform the link switching from the first link to the second link.

According to still another aspect of the present disclosure, there is provided a network communication system comprising the link switching device according to some embodiments of the present disclosure, a first network device communicatively connected to the link switching device, and a second network device connected to the first network device through a first link, wherein the first network device comprises: a receiving module configured to receive a pre-configured data packet from the link switching device, and a link switching module configured to invoke the pre-configured data packet to perform a link switching from the first link to a second link.

According to yet still another aspect of the present disclosure, there is provided a computer-readable storage medium storing computer-readable instructions that, when executed, perform the link switching method according to some embodiments of the present disclosure.

### BRIEF DESCRIPTION OF THE DRAWINGS

FIG. 1 schematically illustrates an application environment of a link switching method according to some embodiments of the present disclosure;

FIG. 2 schematically illustrates a flowchart of a link switching method according to some embodiments of the present disclosure;

FIG. 3 schematically illustrates a flowchart of a link switching method according to some embodiments of the present disclosure;

FIG. 4 schematically illustrates a flowchart of a link switching method according to other embodiments of the present disclosure;

FIG. 5 schematically illustrates a structural block diagram of a link switching device according to some embodiments of the present disclosure; and

FIG. 6 schematically illustrates a structural block diagram of a network communication system according to some embodiments of the present disclosure.

### DETAILED DESCRIPTION OF THE DISCLOSURE

In order to make the above objects, features, and advantages of the present disclosure more comprehensible, the present disclosure is described in further detail below with reference to the accompanying drawings and specific embodiments.

Embodiments of the present disclosure will be described in detail below. Examples of the embodiments are shown in the accompanying drawings, wherein the same or similar reference numerals represent the same or similar elements or elements having the same or similar functions throughout. The embodiments described below with reference to the drawings are exemplary, and are intended to explain the present disclosure, and should not be construed as limiting the present disclosure.

With the construction of an enterprise's own data center and cloud center, the scale of enterprise's network is getting larger and larger, and its network architecture is becoming more and more complex. The redundant devices of multi-link and port-aggregated link cannot be automatically switched, and when an abnormality occurs, administrators have to manually change network device configurations to resume service. For example, for a line using an optical fiber transceiver, when the intermediate optical fiber in the actual link is broken, but the optical fiber transceiver is still powered and continuously transmits and receives electrical signals to and from the network device, the network device considers the link to be normal and the data will still be transmitted to the actually disconnected link, which causes service interruption. In this way, network devices cannot detect the true state of active and standby links, and thus cannot automatically switch over the links. This results in longer system failure times and poor system stability.

In view of the above problems, the present disclosure provides a link switching method, a link switching device, and a network communication system. The link switching method mainly uses a script or a tool to monitor network devices and network links. When an abnormality occurs on a network device or a link, the network device related to the failure area is automatically and quickly configured to implement monitoring and automatic switching. The effect is more obvious for complex network architectures with multiple regions, multiple links, and multiple services.

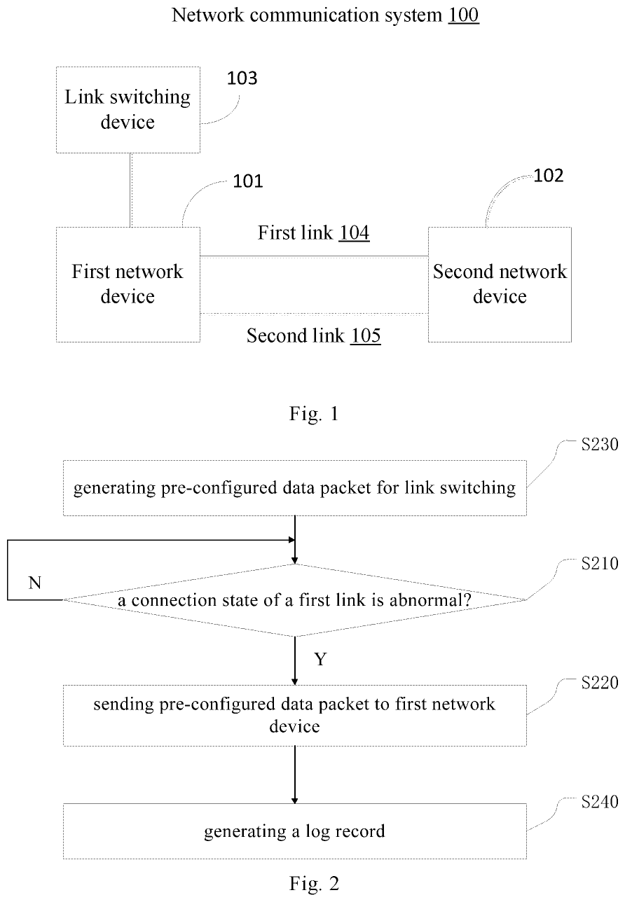

FIG. 1 shows a schematic diagram of an application environment of a link switching method according to some embodiments of the present disclosure. As shown in FIG. 1, the link switching method according to the present disclosure can be applied to a network communication system 100. The network communication system 100 may include: a first network device 101, a second network device 102, and a link switching device 103, wherein the first network device 101 and the second network device 102 are communicatively connected through a first link (or a main link) 104. In addition, as shown by the dotted line in FIG. 1, there is also a second link (or backup link) 105 between the first network device 101 and the second network device 102, which is used to instead implement communication between the first network devices 101 and the second network devices 102 when the main link 104 is abnormal or faulty. The link switching device 103 are communicatively connected with the first network device 101 in a reliable manner to monitor in real time whether the communication connection state of the first link 104 between the first network device 101 and the second network device 102 is abnormal, and to perform a link switching from the first link 104 to the second link 105 when an abnormality occurs. In other words, in the network communication system 100 shown in FIG. 1, a link switching method according to some embodiments of the disclosure may be implemented by the link switching device 103.

In some embodiments, the first network device 101 and the second network device 102 each may be any networked device in the network communication system 100, such as a terminal device (e.g., a personal computer, a tablet computer, a mobile phone, etc.), an intermediate device (e.g., a gateway, a switch, a router, a firewall, etc.), servers, etc. In practical applications, both the first link 104 and the second link 105 may be network dedicated line links or virtual private network (VPN) links. In addition, the link form of the first link 104 may be inconsistent with that of the second link 105. For example, when the first link 104 is a network dedicated line link, the second link 105 may be a network dedicated line link or a virtual private network link. Optionally, the first link 104 and second link 105 may also be any other wired or wireless network links capable of implementing communication functions.

In some embodiments, during the link switching process, the first network device 101 receives a pre-configured data packet from the link switching device 103 for implementing a link switching from the first link 104 to the second link 105, and then invokes the configuration script in the pre-configured data packet to replace an original first link configuration item with a second link configuration item, thereby switching the current first link 104 between the first network device 101 and the second network device 102 to the second link 105. The pre-configured data packet is a configuration file, for the link switching between the first network device 101 and the second network device 102, generated in advance by the link switching device 103, which includes, for example, a configuration script and a link configuration item.

Optionally, the link configuration item may be a setting item or a table entry required to maintain services between the first network device and the second network device. In practical applications, the link configuration item may be updated based on the change of the service between the two network devices. The link configuration item may include an access control lists, a routing priority configuration item, a routing configuration item, a port disable configuration item, and so on. The access control list can be used to determine which data packets can be received and which packets need to be rejected. If there is no access control list, the network device can also perform regular forwarding processing on the data packets. When multiple next-hop devices are configured in the first network device, the routing priority configuration item may be used to determine which next-hop device a data packet needs to be sent in priority to. In the embodiment of the present disclosure, the port corresponding to the second network device has the highest priority. The routing configuration item may include a static routing configuration item or a policy routing configuration item, and may be used to determine a next-hop device to which a data packet needs to be sent. The port disable configuration item can be used to disable the port corresponding to the first link in the first network device, so that the first network device will not subsequently send data to the second network device through the port corresponding to the first link. If the priorities of the ports for the first link and the second link are set, and the priority of the port for the first link is higher, when the port for the first link is disabled, only the port for the second link is available and thus the first network device can send data to the second network device through the port for the second link.

In addition, the configuration script is also a configuration tool for the link configuration item. The network device may invoke and execute the configuration script locally to configure the link configuration item in the network device. In practical applications, the configuration script may be specifically written in a scripting language such as VBS (Microsoft Visual Basic Script Edition) and Java, and embodiments of the present disclosure do not specifically limit in this regard.

Optionally, although not shown in FIG. 1, the link switching device 103 may also be communicatively connected with the second network device 102 to perform link switching through the second network device 102. In addition, in some cases, the link switching requires modification of the link configurations by both communication parties, so the reliable connection between the link switching device 103 and the second network device 102 can implement the modification of the link configuration at the second network device 102 to complete the link switching.

Optionally, in some embodiments, for some first network devices 101 capable of program compiling and running, such as a client computer, a server, etc., the link switching method according to the present disclosure may be directly implemented on the first network device 101 while omitting the link switching device 103.

FIG. 2 illustrates a flowchart of a link switching method according to some embodiments of the present disclosure. As shown in FIG. 2, the link switching method according to some embodiments of the present disclosure may include the following steps S210-S220. The above method steps are described in detail below.

S210, a link monitoring step: monitoring whether a connection state of a first link between a first network device and a second network device is abnormal.

For large and very large enterprise network architectures involving for example multiple territories and multiple services, central node device (such as the hub of the entire network system) or key network device needs to be specially monitored to monitor whether its working state or connection state is normal to ensure safe and stable operation of the entire network architecture. In some embodiments of the present disclosure, as shown in FIG. 1, in the network communication system 100, the first network device 101 may be regarded as a central node or a key network device, and a link switching device 103 connected thereto is used for monitoring the communication connection state of the first network device 101, for example, monitoring whether the first link being used between the first network device 101 and the second network device 102 is normally connected.

In practical applications, a first link 104 between the first network device 101 and the second network device 102 may be established in advance, so that the first network device 101 may transmit data to the second network device 102 through the first link 104. The link switching device 103 can monitor in real time whether the connection state of the first link 104 is abnormal by means of a secure and reliable connection with the first network device 101, so as to monitor whether the first network device can normally transmit data to the second network device. As shown in FIG. 2, when it is detected that the first link 104 is abnormally connected, the link switching device 103 may go to step S220 to perform link switching.

S220, a pre-configured data packet sending step: in response to the monitored connection state of the first link being abnormal, sending a pre-configured data packet to the first network device for being invoked by the first network device to perform a link switching from the first link to a second link.

In some embodiments according to the present disclosure, as shown in FIG. 1, in order to prevent a situation in which the first link 104 is abnormal to make the first network device 101 unable to transmit data to the second network device 102, a second link 105 between the first network device 101 and the second network device 102 may be established in advance, which serves as a backup link. When the connection state of the first link 104 (or the main link) is normal, the second link 105 can be disabled; and when the connection state of the first link 104 is abnormal, the second link 105 can be enabled after configured.

As shown in step S220, when the abnormality of the first link is monitored, it can be determined that the first network device cannot normally transmit data to the second network device. In this case, the link switching can be initiated in the following manner: a pre-configured data packet for switching the first link to the second link may be sent from the link switching device to the first network device for being invoked by the first network device to perform a corresponding switching operation. The pre-configured data packet refers to a pre-configured data packet stored in the link switching device and used for switching from the first link to the second link by the first network device. Specifically, the pre-configured data packet may include a link configuration item and a configuration script required to maintain a communication service between the first network device and the second network device, and the configuration script is a configuration tool for the link configuration item. The pre-stored link configuration item in the pre-configured data packet can be configured in the first network device by invoking the configuration script to enable the second link, so that the first network device can subsequently send data to the second network device through the second link.

In the link switching method according to some embodiments of the present disclosure, since real-time and active monitoring of the operating state or connection state of important nodes or central node devices is performed at any time according to user's requirements, communication link failure alarms and records can be found at the first time. In addition, according to the pre-configured file which is pre-stored corresponding to the monitoring target device (i.e., important node), the communication link can be switched in time to quickly handle the connection failure. Compared with the related art, the link switching method according to the present disclosure can implement network device monitoring and emergency communication failure handling (for example, automatically changing the configuration to implement link switching), and, in large and very large network architectures involving multiple territories and multiple services, its efficiency is outstanding. This link switching method is easy to operate, since it only needs to make configuration preparations for important network node devices in advance and monitor them and when a failure occurs, it can automatically complete switch of routings, port settings, and even devices. Moreover, this link switching method does not require the administrator to manually switch links, which can perform link switching in a case in which the administrator cannot handle the failure in time, to avoid service interruption for a long time.

For comparison between the link switching method of the present disclosure and the manual switching method of the related art, the reference to Table 1 can be made.

Table 1—Comparison of a link switching method according to some embodiments of the present disclosure with related art:

TABLE 1
Comparison of a link switching method according to some
embodiments of the present disclosure with related art:

| Link switching method | Process | Efficiency and effect |
|---|---|---|
| Related art | 1. The network failure is alarmed | Complex and inefficient: |
| | by the monitoring software or | 1. For a failure of single-territory |
| | found artificially; | network, a network administrator |
| | 2. The administrators troubleshoot; | is required to be in place (the |
| | 3. A single-territory network can | commuting time of administrator |
| | operate immediately after | for dealing with network failures |
| | troubleshooting; | in non-working hours need to be |
| | 4. For multi-territory service, | considered); |
| | multi-territory joint commissioning | 2. For a failure of multi-territory |
| | is needed, and thus other | network, administrators of multiple |
| | corresponding territorial | parts are required to be in place |
| | administrators need to be contacted | and communicate well (a situation |
| | to commission at the same time. | where some administrators cannot |
| | | be contacted at individual periods |
| | | need to be considered). |
| Present disclosure | 1. Monitoring important network | Simple and efficient: |
| | nodes in advance; | The device link failure can be |
| | 2. After a failure being monitored, | monitored automatically, and the |
| | automatically configuring the | link switching and failure handling |
| | device to restore network, | can be performed automatically. |

In some embodiments, as shown in FIG. 2, before S220-link monitoring step, the link switching method according to the present disclosure may further include:

S230, a pre-configured data packet generation step: generating a pre-configured data packet for the first network device, wherein the pre-configured data packet includes a link configuration item and a configuration script required for switching the first link to the second link.

In the link switching method according to the present disclosure, for an important node network device to be monitored, i.e. a first network device, a pre-configured data packet for switching a first link to a second link needs to be made in advance, for being sent to the first network device to implement the link switching, including route changes and port configuration etc., during the link switching process. The pre-configured data packet may include a link configuration item and a configuration script required to maintain communication services between the first network device and the second network device, and the configuration script is a configuration tool for the link configuration item.

In specific applications, the link configuration to be modified can be written into a text file in advance, and the user pre-defined configuration file can write various device configuration files according to the user's needs, such as writing ACLs, Shutdown ports, adjusting routing priorities, and writing PBR, etc., to add or delete network device configuration or even power-off or restart the device. Different configuration files can be written respectively by users for different devices and services to be monitored. The switching tool is written and invoked by means of DOS, the Start statement opens the Telnet program, and the Cscript statement invokes the VBS script tool. The VBS tool sets objects and variables by means of the WScript.CreateObject statement, references the preset configuration in the user's xml file, and uses the SendKeys statement to send the content of the configuration file to the device of which the configuration needs to be modified and to execute it.

In some embodiments, as shown in FIG. 2, the link switching method according to the present disclosure may further include the following step:

S240, a log record generation step: after completing each step of the link switching method, generating a log record of the step.

In the link switching method according to the present disclosure, while various steps, such as steps of monitoring the connection state of the first link between the first network device and the second network device, sending a pre-configured data packet to the first network device, and making or generating the pre-configured data package, are being performed, relevant logs may be automatically generated to record the completion of the work and corresponding data in the corresponding steps, which is conducive to retrospective troubleshooting in the future so as to summarize success experience and draw lessons of failures therefrom and thus improve working way.

Optionally, a link switching device can also be configured behind the second network device, and the link configuration can also be performed in the second network device through the link switching device behind the second network device in the same configuration manner as the first network device, so that the second network device can subsequently send data to the first network device through the second link, and the interactive service between the two devices can be realized through the second link.

In practical applications, in some scenarios, the switching to the second link can be completed only by configuring the link configuration item of the second link on the first network device side, and the communication is performed through the second link. For example, a first network device only performs the service of sending data to the second network device, and the second network device will perform indiscriminate processing on the received data. In this case, by configuring the next-hop device only on the first network device side as the second network device and switching the port for sending data, the link switching can be completed.

In other scenarios, the configuration of the second link needs to be performed on the first network device side and the second network device side, respectively, in order to complete the switching to the second link and communicate through the second link. For example, the first network device can send data to the second network device, and the second network device also needs to send data to the first network device, or needs to perform selective processing on the received data. In such a case, after the configuration on the first network device side is completed, the configuration such as the port receiving and sending data may change, which will affect the services of the second network device. Therefore, while the link configuration is performed on the first network device side through the link switching device behind the first network device, the link configuration on the second network device is also necessary to be performed through the link switching device behind the second network device, so that the link switching can be completed.

In some embodiments, the link switching method according to the present disclosure may further include: in response to the monitored connection state of the first link being abnormal, while sending a pre-configured data packet to the first network device, sending a further pre-configured data packet to the second network device for being invoked by the second network device to perform a link switching from the first link to the second link.

Optionally, the first network device and the second network device may be monitored by the same link switching device. Therefore, the link switching device 103 shown in FIG. 1 can be connected to the second network device 102 while being connected to the first network device 101. In the scenario where the link switching requires the two communication parties to modify the link configuration separately, the reliable connections of the link switching device 103 with the first network device 101 and the second network device 102 respectively can implement the modification of the link configuration of the two network device, thereby completing the link switch.

It should be noted that, because the specific manners in which the first network device and the second network device process services are different, when the link configurations are performed in the first network device and the second network device simultaneously, the required configuration data packets will also be different.

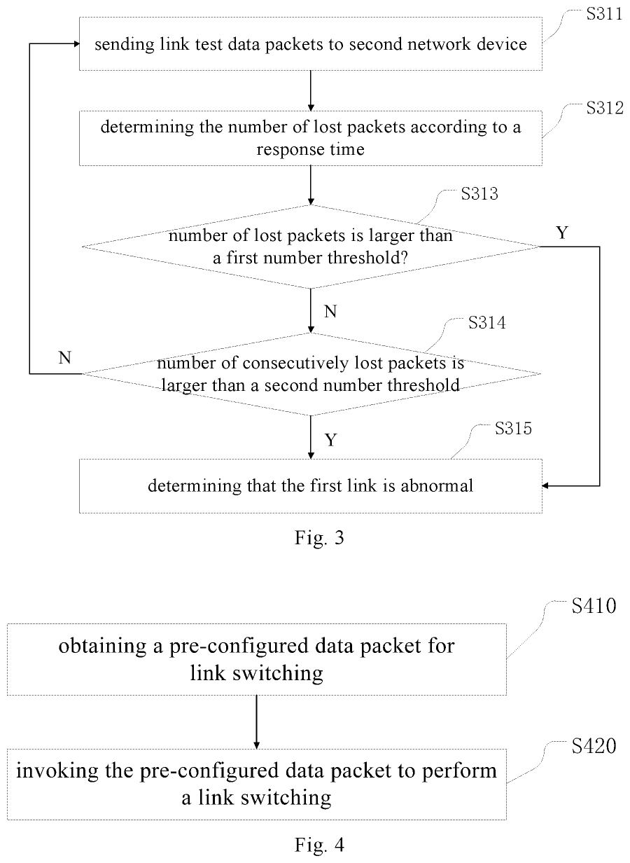

FIG. 3 illustrates a flowchart of a link switching method according to some embodiments of the present disclosure. As shown in FIG. 3, step S210-monitoring whether the connection state of the first link between the first network device and the second network device is abnormal shown in FIG. 2, includes the following steps S311-S313.

S311, sending one or more link test data packets to the second network device via the first network device to request a response message of the second network device.

In some embodiments according to the present disclosure, the link switching device may monitor the connection state of the first link between the first network device and the second network device by a link detection command, such as a ping (Packet Internet Groper) command, a SNMP (Simple Network Management Protocol) command, and the like. The link detection command can be sent at a set interval to monitor the connection state of the first link in real time. Specifically, the link switching device may store an IP (Internet Protocol) address of the second network device, and the link switching device may send a link detection command to the IP address of the second network device via the first network device. The link detection command may include a certain number of link test data packets. Each time the second network device receives a test data packet, it can return a response message to the link switching device via the first network device. When the connection state of the first link is normal, the second network device can receive all test data packets, or at least most of the test data packets, and the response time of the second network device to return each of response data packets is short. When the connection state of the first link is abnormal, the second network device may only receive a small number of test data packets, or cannot receive any test data packet at all, or the response time of the second network device to return each of the response data packets is too long to satisfy the timeliness of service processing. Therefore, the link switching device can monitor the connection state of the first link by means of the link test data packet in the link detection command.

In addition, in practical applications, the link detection command may specifically be a DOS (Disk Operating System) command, and the link switching device may send a link detection command to the second network device using a message protocol such as ICMP (Internet Control Message Protocol). The second network device can also use a message protocol such as ICMP to return a response message to the link switching device, and thus both the link test data packet and the response message can be messages in the message protocol such as ICMP.

S312: determining whether each of the one or more link test data packets is lost according to whether a response message of the second network device is received within a first time threshold since the link test data packet being sent, thereby determining a number of the lost link test data packets.

In some embodiments of the present disclosure, each time the second network device receives a test data packet, the second network device may return a response message to the link switching device via the first network device, and the number of response messages returned by the second network device and the response time of each response message returned by the second network device may each represent the connection state of the first link. Therefore, the link switching device can count at least one of the number of response data packets returned by the second network device and the response time of the second network device to the link detection command. Specifically, the number of response messages and the response time can be combined to determine whether the first link is abnormal. For example, it can be defined whether the link test data packet is lost according to the response time of the response message. For example, if the feedback time of a response message exceeds a certain threshold, e.g., the first time threshold, it is determined that the link test data packet is lost. Specifically, while sending each link test data packet, the timer can be used to start timing. If no response message is received until the timer reaches the first time threshold (e.g., 5 seconds, or more or less than 5 seconds), it can be considered that the link test data packet is lost. Subsequently, the connection state of the first link can be determined according to the packet loss situation. For example, when the number of lost packets is large, e.g., reaches a certain threshold, the connection state is considered abnormal, then a link switching is required to restore network communication.

S313: determining whether the number of lost link test data packets is greater than a first number threshold. If so, go to step S315 to determine that the connection state of the first link is abnormal; otherwise, go to step S314.

S314: determining whether the number of consecutively lost link test data packets is greater than a second number threshold. If so, go to step S315 to determine that the connection state of the first link is abnormal; otherwise, return to step S311 to resend the link test data packet.

S315: determining that the connection state of the first link is abnormal in response to at least one of: the number of lost packets in one or more link test data packets is greater than the first number threshold; or the number of the consecutively lost link test data packets of the one or more link test data is greater than the second number threshold.

In some embodiments, a first number threshold may be set in advance as the threshold for packet loss, and if the number of packet loss exceeds the first number threshold, it can be determined that the connection state is abnormal. For example, assuming that the link switching device can send a ping command to the second network device via the first network device, the ping command includes 25 test data packets, and the number threshold of packet loss, i.e. the first number threshold, is 8, if the number of the response messages returned by the network device within the first threshold time since receiving the ping command is 15 and thus the number of packet loss is 10, which exceeds the first number threshold of 8, it can be determined that the connection state of the first link is abnormal.

On the other hand, it can also be determined whether the connection state of the first link is abnormal according to the consecutive packet loss of the test data packet. Generally, the sending of one or more test data packets can be performed one after the other. If several test data packets sent in succession are lost, that is, consecutive packet loss occurs, compared with the discontinuous packet loss with the same number of packet loss, the connection state of the first link is obviously worse. Therefore, a second number threshold may be set in advance as a threshold for consecutive packet loss. If the number of consecutive packet losses exceeds the second number threshold, the connection state may be considered abnormal. Optionally, since consecutive packet loss is more severe than discontinuous packet loss, the second number threshold may be set to be smaller than the first number threshold to more accurately reflect the real situation.

FIG. 4 shows a flowchart of a link switching method according to some other embodiments of the present disclosure. As shown in FIG. 4, the link switching method includes:

S410: obtaining a pre-configured data packet for switching a first link between a first network device and a second network device to a second link; and

S420: invoking the pre-configured data packet to perform a link switching from the first link to the second link.

The link switching method shown in FIG. 4 may be completed by the first network device 101 shown in FIG. 1. Specifically, the first network device 101 may receive or obtain a pre-configured data packet from the link switching device 103 for link switching, and then invoke the pre-configured data packet to perform the switching from the first link to the second link. In some embodiments, the pre-configured data packet may include a configuration script and a link configuration item required to switch the first link to the second link.

Therefore, step S420-invoking the pre-configured data packet to perform a link switching from the first link to the second link shown in FIG. 4, may include: invoking the configuration script in the pre-configured data packet to replace the link configuration item of the first link with the link configuration item in the pre-configuration data packet; or invoking the configuration script in the pre-configured data packet to disable the link configuration item of the first link and enable the link configuration item in the pre-configuration data packet. In the first implementation, when the first network device receives the pre-configuration data packet, it may invoke the configuration script to replace the link configuration item of the first link with the link configuration item of the second link. Thus, only the link configuration item of the second link is configured in the first network device, so that the second link can be enabled in the first network device. In the second implementation, when the first network device receives the pre-configuration data packet, it may call the configuration script to disable the link configuration item of the first link and enable the link configuration item of the second link. Thus, only the link configuration item of the second link is available in the first network device, so that the second link can be enabled in the first network device.

In some embodiments, the second link may be a virtual private network link. The virtual private network link transmits data through channel encryption in a public network and thus its physical link actually uses the public network link that has been set up already. Therefore, when the second link is a virtual private network link, the actual physical link corresponding to the second link does not need to be set up in advance, and it is only necessary to make a setup for the virtual private network in the first network device and the second network device, thereby saving the cost of laying the physical link. In addition, the actual physical link is prone to failure and aging problems when it is not enabled or maintained for a long time, which causes link switching failures. The virtual private network link uses a public network link that is always in use, so such problem can be avoided. For example, when the first network device receives the pre-configuration data packet, it can invoke the configuration script in the pre-configuration data packet to replace the access control list of the first link with the access control list in the pre-configuration data packet, to enable the second link in the first network device.

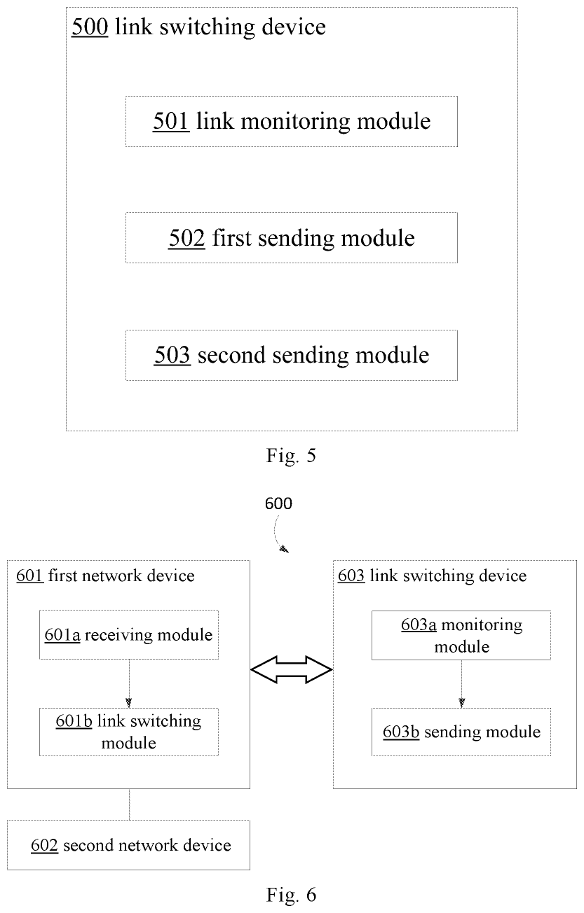

FIG. 5 illustrates a structural block diagram of a link switching device according to some embodiments of the present disclosure. As described above, the link switching method according to some embodiments of the present disclosure (see, for example, FIG. 2 to FIG. 3) may be completed by a link switching device similar to that shown in FIG. 5. As shown in FIG. 5, the link switching device 500 includes:

a link monitoring module 501 configured to monitor whether a connection state of a first link between a first network device and a second network device is abnormal;

a first sending module 502 configured to in response to the monitored connection state of the first link being abnormal, send a first pre-configured data packet to the first network device for being invoked by the first network device to perform a link switching from the first link to a second link.

In some embodiments, as shown in FIG. 5, the link switching device 500 may further include:

a second sending module 503 configured to in response to the monitored connection state of the first link being abnormal, send a second pre-configured data packet to the second network device for being invoked by the second network device to perform the switching from the first link to the second link.

Accordingly, the present disclosure also provides a computer-readable storage medium having stored thereon computer-readable instructions that, when executed, perform the link switching method according to some embodiments of the present disclosure.

FIG. 6 schematically illustrates a structural block diagram of a network communication system according to some embodiments of the present disclosure. As shown in FIG. 6, a network communication system 600 according to some embodiments of the present disclosure includes:

a first network device 601,

a second network device 602 connected to the first network device 601 through a first link, and

a link switching device 603 communicatively connected to the first network device 601.

The first network device 601 includes: a receiving module 601a configured to receive a pre-configured data packet from the link switching device 603, and a link switching module 601b configured to invoke the pre-configured data packet to perform a link switching from the first link to a second link.

In the network communication system 600 shown in FIG. 6, the link switching device 603 may be similar to the link switching device 500 shown in FIG. 5. Thus, the link switching device 603 may include: a link monitoring module 603a configured to monitor whether the connection state of the first link between the first network device 601 and the second network device 602 is abnormal; and a sending module 603b configured to in response to the monitored connection state of the first link being abnormal, send a pre-configured data packet to the first network device 601 for being invoked by the first network device 601 to perform a link switching from the first link to the second link.

In the description of the present specification, the descriptions of the terms “one embodiment”, “some embodiments”, “example”, “specific examples”, or “some examples” and the like are intended to mean the specific features, structures, materials or characteristics described in connection with the embodiments or examples are comprised in at least one embodiment or example of the present disclosure. In the present specification, the schematic representation of the above terms is not necessarily directed to the same embodiment or example. Furthermore, the specific features, structures, materials, or characteristics described may be combined in a suitable manner in any one or more embodiments or examples. In addition, various embodiments or examples described in the specification, as well as features of various embodiments or examples, may be combined or integrated by those skilled in the art without conflicting.

Any process or method description in the flowcharts or otherwise described herein can be understood to represent a module, segment or portion of code comprising one or more executable instructions for implementing the steps of a custom logic function or process. The scope of the optional embodiments of the present disclosure comprises additional implementations in which the functions may be performed in an order not shown or discussed, e.g., in a substantially simultaneous manner or in a reverse order, depending on the function involved, which will be understood by those skilled in the art to which the embodiments of the present disclosure belongs.

The logic and/or steps represented in the flowchart or otherwise described herein, for example, may be considered as an ordered list of executable instructions for implementing logical functions, and may be embodied in any computer readable medium to be used by, or in conjunction with, an instruction execution system, apparatus, or device (e.g., a computer-based system, a system comprising a processor, or other system that can read and execute instructions from, an instruction execution system, apparatus, or device). In this specification, a “computer-readable medium” can be any apparatus that can contain, store, communicate, propagate, or transport a program for use in an instruction execution system, apparatus, or device, or in conjunction with such an instruction execution system, apparatus, or device. More specific examples of the computer readable medium may comprise, for example, an electrical connection (electronic device) having one or more wires, a portable computer disk (magnetic device), a random access memory, read only memory, erasable programmable read only memory or flash memory, optical fiber devices, and compact disc read only memory. In addition, the computer readable medium may even be a paper or other suitable medium on which the program can be printed, as the paper or other medium may be optically scanned, followed by edition, interpretation or, if appropriate, other suitable manner to obtain the program electronically and then store it in computer memory.

It should be understood that, various parts of the present disclosure can be implemented in hardware, software, firmware, or a combination thereof. In the above-described embodiments, multiple steps or methods may be implemented in software or firmware stored in a memory and executed by a suitable instruction execution system. For example, if implemented in hardware, it can be implemented by any one or combination of the following techniques well known in the art: discrete logic circuits with logic gate circuits for implementing logic functions on data signals, application specific integrated circuit with appropriate combinational logic gate circuits, programmable gate array, field programmable gate array, and the like.

One of ordinary skill in the art will appreciate that all or part of the steps of the above-described embodiments may be performed by hardware associated with program instructions, which may be stored in a computer readable storage medium and may comprise, when executed, one or a combination of the steps of the execution method embodiments.

In addition, each functional unit in various embodiments of the present disclosure may be integrated into one processing module, or each unit may exist physically separately, or two or more units may be integrated into one module. The above integrated modules can be implemented in the form of hardware or in the form of software functional modules. The integrated modules, if implemented in the form of software functional modules and sold or used as separate products, may also be stored in a computer readable storage medium.

Each embodiment in this specification is described in a progressive manner. Each embodiment focuses on the differences from other embodiments, and the same or similar parts between the various embodiments may refer to each other.

Finally, it should be noted that in this disclosure, relational terms such as first and second are used only to distinguish one entity or operation from another entity or operation, and do not necessarily require or imply there is any such actual relationship or order between these entities or operations. Moreover, the terms “comprising,” “including,” or any other variation thereof are intended to encompass non-exclusive inclusion, such that a process, method, product, or device that includes a series of elements includes not only those elements but also those that are not explicitly listed, or elements that are inherent to such a process, method, product or devices. Without more restrictions, the elements defined by the sentence “including a . . . ” do not exclude the existence of other identical elements in the process, method, product or device including the elements.

Specific examples are used herein to explain the principles and implementations of the present disclosure. The descriptions of the above embodiments are only used to help understand the methods and core ideas of the present disclosure. Meanwhile, for a person of ordinary skill in the art, based on the present disclosure, specific implementations and applications may be changed. In summary, the content of this description should not be construed as a limitation on the present disclosure.

1. A link switching method, comprising:
monitoring whether a connection state of a first link between a first network device and a second network device is abnormal; and
in response to the monitored connection state of the first link being abnormal, sending a pre-configured data packet to the first network device for being invoked by the first network device to perform a link switching from the first link to a second link.

2. The link switching method according to claim 1, further comprising: generating the pre-configured data packet for the first network device before the sending the pre-configured data packet to the first network device, wherein the pre-configured data packet comprises a link configuration item and a configuration script required for switching the first link to the second link.

3. The link switching method according to claim 1, wherein the monitoring whether the connection state of the first link between the first network device and the second network device is abnormal comprises:
sending one or more link test data packets to the second network device via the first network device to request a response message of the second network device;
in response to no response message of the second network device being received within a first time threshold since each of the one or more link test data packets being sent, determining that the link test data packet is lost; and
determining that the connection state of the first link is abnormal according to at least one of: a number of lost link test data packets in the one or more link test data packets is greater than a first number threshold, or a number of consecutively lost link test data packets in the one or more link test data packets is greater than a second number threshold.

4. The link switching method according to claim 1, further comprising:
after completing each step of the method, generating a log record of the step.

5. The link switching method according to claim 1, wherein at least one of the first link and the second link is a network dedicated line link or a virtual private network link.

6. The link switching method according to claim 2, wherein the link configuration item comprises at least one of an access control list, a routing priority configuration item, a routing configuration item, and a port disable configuration item.

7. The link switching method according to claim 1, further comprising, in response to the monitored connection state of the first link being abnormal, while sending the pre-configured data packet to the first network device, sending a further pre-configured data packet to the second network device for being invoked by the second network device to perform the link switching from the first link to the second link.

8. The link switching method according to claim 1, wherein each of the first network device and the second network device comprises at least one of a switch, a router, a firewall, a server, and a client.

9. A link switching method, comprising:
obtaining a pre-configured data packet for switching a first link between a first network device and a second network device to a second link; and
invoking the pre-configured data packet to perform a link switching from the first link to the second link.

10. The link switching method of claim 9, wherein the pre-configured data packet comprises a configuration script and a link configuration item required for switching the first link to the second link, and wherein the invoking the pre-configured data packet to perform the link switching from the first link to the second link comprises:
invoking the configuration script in the pre-configured data packet to replace the link configuration item of the first link with the link configuration item in the pre-configuration data packet; or
invoking the configuration script in the pre-configured data packet to disable the link configuration item of the first link and enable the link configuration item in the pre-configuration data packet.

11. A link switching device, comprising:
a link monitoring module configured to monitor whether a connection state of a first link between a first network device and a second network device is abnormal;
a first pre-configured data packet sending module configured to in response to the monitored connection state of the first link being abnormal, send a first pre-configured data packet to the first network device for being invoked by the first network device to perform a link switching from the first link to a second link.

12. The link switching device according to claim 11, further comprising:
a second pre-configured data packet sending module configured to in response to the monitored connection state of the first link being abnormal, send a second pre-configured data packet to the second network device for being invoked by the second network device to perform the link switching from the first link to the second link.

13. A network communication system, comprising the link switching device according to claim 11, a first network device communicatively connected to the link switching device, and a second network device connected to the first network device through a first link,
wherein the first network device comprises: a receiving module configured to receive a pre-configured data packet from the link switching device, and a link switching module configured to invoke the pre-configured data packet to perform a switch from the first link to a second link.

14. A computer-readable storage medium storing computer-readable instructions that, when executed, perform the link switching method according to claim 1.

15. The link switching method according to claim 2, further comprising: after completing each step of the method, generating a log record of the step.

16. A computer-readable storage medium storing computer-readable instructions that, when executed, perform the link switching method according to claim 9.
